(19) United States
(12) Patent Application Publication
(10) Pub. No.: US 2025/0123581 A1
(43) Pub. Date: Apr. 17, 2025

(54) IMAGE FORMING APPARATUS AND IMAGE FORMING METHOD

(71) Applicant: FUJIFILM Business Innovation Corp., Tokyo (JP)

(72) Inventors: Yasuhisa MOROOKA, Kanagawa (JP); Masataka KURIBAYASHI, Kanagawa (JP); Naoki OTA, Kanagawa (JP); Yusuke FUKUDA, Kanagawa (JP); Katsuyuki KITAJIMA, Kanagawa (JP); Teppei YAWADA, Kanagawa (JP); Shota OSHIMA, Kanagawa (JP); Tatsuhiro IGARASHI, Kanagawa (JP)

(73) Assignee: FUJIFILM Business Innovation Corp., Tokyo (JP)

(21) Appl. No.: 18/901,436

(22) Filed: Sep. 30, 2024

(30) Foreign Application Priority Data
Oct. 13, 2023 (JP) 2023-177754
Apr. 26, 2024 (JP) 2024-073133

(51) Int. Cl. G03G 15/16; G03G 9/08; G03G 15/00; G03G 15/01; G03G 15/20

(52) U.S. Cl. CPC G03G 15/161; G03G 9/0819; G03G 15/0131; G03G 15/0189; G03G 15/2017; G03G 15/2064; G03G 15/6558

(57) ABSTRACT

An image forming apparatus includes an electrophotographic photoreceptor, a charging device that charges a surface of the electrophotographic photoreceptor, an electrostatic charge image creating device that creates an electrostatic charge image on the charged surface of the electrophotographic photoreceptor, a developing device that houses an electrostatic charge image developer containing toner and develops the electrostatic charge image created on the surface of the electrophotographic photoreceptor into a toner image by supplying the electrostatic charge image developer, an intermediate transfer body having a surface onto which the toner image is transferred, a first transfer device that transfers the toner image formed on the surface of the electrophotographic photoreceptor to the surface of the intermediate transfer body, a second transfer device that transfers the toner image on the surface of the intermediate transfer body to a surface of recording paper, a fixing device that fixes the toner image onto the surface of the recording paper, a first heating device that heats the toner image transferred to the surface of the intermediate transfer body before the second transfer device transfers the toner image to the surface of the recording paper, and a second heating device that heats the recording paper before the second transfer device transfers the toner image to the surface of the recording paper.

### CROSS-REFERENCE TO RELATED APPLICATIONS

This application is based on and claims priority under 35 USC 119 from Japanese Patent Application No. 2023-177754 filed Oct. 13, 2023, and Japanese Patent Application No. 2024-073133 filed Apr. 26, 2024.

### BACKGROUND

### (i) Technical Field

The present disclosure relates to an image forming apparatus and an image forming method.

### (ii) Related Art

Image formation by electrophotography is performed by, for example, charging the surface of a photoreceptor, then creating an electrostatic charge image on this surface of the photoreceptor in accordance with image information, subsequently developing this electrostatic charge image with a developer containing toner to form a toner image, and transferring and fixing this toner image onto the surface of a recording medium.

In Japanese Unexamined Patent Application Publication No. 2002-123114, there is disclosed “an image forming method, comprising: a transfer step in which a toner image formed on an image bearing member is transferred onto an intermediate transfer member; and a simultaneous transfer and fixing step in which the toner image on the intermediate transfer member is simultaneously transferred and fixed onto a recording medium, wherein: the toner forming the toner image contains at least a binder resin and a colorant, and the toner has a storage elastic modulus (G′) of 2×10² to 6×10³ Pa at a temperature at which a loss elastic modulus (G″) of the toner reaches 1×10⁴ Pa, and, in the simultaneous transfer and fixing step, the simultaneous transfer and fixing is performed using a fixing unit that includes a fixing roll coated with an elastic member, a heat-resistant belt laid across in a tensioned condition with support rolls and urged against the fixing roll to form a nip with the fixing roll, and a pressure roll mounted inside the heat-resistant belt that twists the elastic member of the fixing roll at an exit of the nip through the heat-resistant belt.”

In Japanese Unexamined Patent Application Publication No. 2000-112249, there is disclosed “an image forming apparatus comprising an image carrier having a surface on which a toner image is formed; a toner image forming component that forms the toner image on the image carrier; an intermediate transfer body that circulates along a pathway extending through a first transfer point and a predetermined transfer and fixation point, the first transfer point being on or near the image carrier, and receives the toner image transferred from the image carrier on a surface thereof at the first transfer point, and transports the toner image to the transfer and fixation point; a first transfer component that transfers the toner image on the image carrier to the intermediate transfer body at the first transfer point; a recording body transport component that transports a recording body to the transfer and fixation point; a transfer and fixation component that, at the transfer and fixation point, pressurizes and heats the toner image transferred to the intermediate transfer body by the first transfer component by sandwiching the toner image between the intermediate transfer body and the recording body and thus simultaneously transfers and fixes the toner image on the intermediate transfer body onto the recording body; and a heating component that is positioned upstream of the first transfer point and downstream of the transfer and fixation point on the pathway along which the intermediate transfer body circulates and that heats the intermediate transfer body at a temperature lower than a temperature to which the transfer and fixation component heats the toner image.”

### SUMMARY

Aspects of non-limiting embodiments of the present disclosure relate to an image forming apparatus that includes an electrophotographic photoreceptor, a charging device that charges the surface of the electrophotographic photoreceptor, an electrostatic charge image creating device that creates an electrostatic charge image on the charged surface of the electrophotographic photoreceptor, a developing device that houses an electrostatic charge image developer containing toner and develops the electrostatic charge image created on the surface of the electrophotographic photoreceptor into a toner image by supplying the electrostatic charge image developer, an intermediate transfer body having a surface onto which the toner image is transferred, a first transfer device that transfers the toner image formed on the surface of the electrophotographic photoreceptor to the surface of the intermediate transfer body, a second transfer device that transfers the toner image on the surface of the intermediate transfer body to the surface of recording paper, and a fixing device that fixes the toner image onto the surface of the recording paper, and that may offer reduced image density unevenness in high-temperature and high-humidity environments compared with when the apparatus lacks a first heating device that heats the toner image transferred to the surface of the intermediate transfer body before the second transfer device transfers the toner image to the surface of the recording paper and a second heating device that heats the recording paper before the second transfer device transfers the toner image to the surface of the recording paper.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including an electrophotographic photoreceptor; a charging device that charges a surface of the electrophotographic photoreceptor; an electrostatic charge image creating device that creates an electrostatic charge image on the charged surface of the electrophotographic photoreceptor; a developing device that houses an electrostatic charge image developer containing toner and develops the electrostatic charge image created on the surface of the electrophotographic photoreceptor into a toner image by supplying the electrostatic charge image developer; an intermediate transfer body having a surface onto which the toner image is transferred; a first transfer device that transfers the toner image formed on the surface of the electrophotographic photoreceptor to the surface of the intermediate transfer body; a second transfer device that transfers the toner image on the surface of the intermediate transfer body to a surface of recording paper; a fixing device that fixes the toner image onto the surface of the recording paper; a first heating device that heats the toner image transferred to the surface of the intermediate transfer body before the second transfer device transfers the toner image to the surface of the recording paper; and a second heating device that heats the recording paper before the second transfer device transfers the toner image to the surface of the recording paper.

### BRIEF DESCRIPTION OF THE DRAWINGS

An exemplary embodiment of the present disclosure will be described in detail based on the following figures, wherein:

FIG. 1 is a schematic view illustrating the structure of an example of an image forming apparatus according to an exemplary embodiment; and

FIG. 2 is a schematic view illustrating a partial structure of another example of an image forming apparatus according to an exemplary embodiment.

### DETAILED DESCRIPTION

An exemplary embodiment as an example of the present disclosure will now be described.

### Image Forming Apparatus

An image forming apparatus according to an exemplary embodiment includes:
an electrophotographic photoreceptor;
a charging device that charges the surface of the electrophotographic photoreceptor;
an electrostatic charge image creating device that creates an electrostatic charge image on the charged surface of the electrophotographic photoreceptor;
a developing device that houses an electrostatic charge image developer containing toner and develops the electrostatic charge image created on the surface of the electrophotographic photoreceptor into a toner image by supplying the electrostatic charge image developer;
an intermediate transfer body having a surface onto which the toner image is transferred;
a first transfer device that transfers the toner image formed on the surface of the electrophotographic photoreceptor to the surface of the intermediate transfer body (first transfer);
a second transfer device that transfers the toner image on the surface of the intermediate transfer body to the surface of recording paper (second transfer);
a fixing device that fixes the toner image onto the surface of the recording paper;
a first heating device that heats the toner image transferred to the surface of the intermediate transfer body before the second transfer device transfers the toner image to the surface of the recording paper; and
a second heating device that heats the recording paper before the second transfer device transfers the toner image to the surface of the recording paper.

With the image forming apparatus according to this exemplary embodiment, an image forming method according to an exemplary embodiment is performed that includes:
charging the surface of an electrophotographic photoreceptor;
creating an electrostatic charge image on the charged surface of the electrophotographic photoreceptor;
developing the electrostatic charge image created on the surface of the electrophotographic photoreceptor into a toner image by supplying an electrostatic charge image developer containing toner;
transferring the toner image formed on the surface of the electrophotographic photoreceptor to the surface of an intermediate transfer body (first transfer);
transferring the toner image on the surface of the intermediate transfer body to the surface of recording paper (second transfer);
fixing the toner image onto the surface of the recording paper;
heating the toner image transferred to the surface of the intermediate transfer body before the toner image is transferred to the surface of the recording paper (first heating); and
heating the recording paper before the toner image is transferred to the surface of the recording paper (second heating).

Configured as described above, the image forming apparatus according to this exemplary embodiment may offer reduced image density unevenness in high-temperature and high-humidity environments. A possible reason is as follows.

An image forming apparatus of intermediate transfer type uses a high transfer voltage during the second transfer, i.e., transfer to recording paper, because multiple toner layers are overlaid on the intermediate transfer body.

In high-temperature and high-humidity environments, an increased water content, and the resulting reduced resistance, of the toner and the recording paper lead to easier migration of electric charge into the toner and the recording paper. As a result, charge injection efficiency deteriorates.

In high-temperature and high-humidity environments, therefore, a relatively intense electric field is applied to the toner, and the transfer voltage applied to the toner is inadequate, resulting in reduced transfer efficiency and image density unevenness.

To address this, the image forming apparatus according to this exemplary embodiment uses its first heating device to heat the toner image transferred to the surface of the intermediate transfer body before the second transfer device transfers the toner image to the surface of the recording paper. Additionally, the image forming apparatus uses its second heating device to heat the recording paper before the second transfer device transfers the toner image to the surface of the recording paper.

These may reduce the water content of the toner and the recording paper before the second transfer, and thus may limit the decrease in the resistance of the toner and the recording paper. As a result, the deterioration in charge injection efficiency may be controlled. Consequently, even in high-temperature and high-humidity environments, charge injection into the toner caused by excessively high voltage application to the toner may be constrained; the associated reduction in toner charge and transfer efficiency may be lessened, potentially decreasing the likelihood of image density unevenness.

Presumably for this reason, the image forming apparatus according to this exemplary embodiment may offer reduced image density unevenness in high-temperature and high-humidity environments.

The configuration of the image forming apparatus according to this exemplary embodiment can be applied to known types of image forming apparatuses, such as ones equipped with a static eliminator that removes static electricity from the surface of the photoreceptor by irradiating the surface with antistatic light between the transfer of the toner image and charging.

Incidentally, a portion of the image forming apparatus according to this exemplary embodiment that includes at least the photoreceptor may be in a cartridge structure, which constitutes a unit for the image forming apparatus and allows this portion to be detached from and attached to the image forming apparatus (i.e., may be a process cartridge).

An example of a unit for the image forming apparatus is a unit that includes at least the photoreceptor.

An example of a configuration of the image forming apparatus according to this exemplary embodiment will then be described in detail.

An example of an image forming apparatus according to this exemplary embodiment will now be presented; the apparatus, however, is not limited to this example. Structural elements illustrated in the drawings will be described, and the remaining elements will not be described. The arrow UP in a drawing indicates the vertically upward direction.

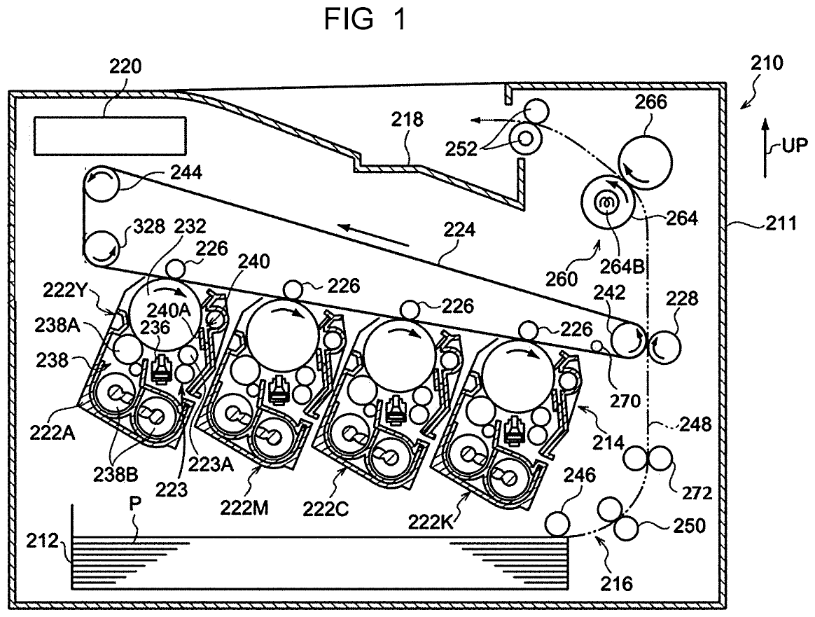

FIG. 1 is a schematic view illustrating the structure of an example of an image forming apparatus according to this exemplary embodiment.

### Structural Elements of the Image Forming Apparatus

As illustrated in FIG. 1, the image forming apparatus 210 includes an image forming apparatus body 211, inside which the individual components are housed. Inside the image forming apparatus body 211, there are a container section 212, in which recording paper P is stored, an image forming section 214, which forms an image on the recording paper P, and a transport section 216, which transports the recording paper P from the container section 212 to the image forming section 214. In an upper portion of the image forming apparatus body 211, there is an ejection section 218, to which the recording paper P with the image formed thereon by the image forming section 214 is ejected. There is also a controller 220 inside the image forming apparatus body 211, which controls the operation of each section of the image forming apparatus 210.

The image forming section 214 includes image forming units 222Y, 222M, 222C, and 222K that form toner images in the colors of yellow (Y), magenta (M), cyan (C), and black (K), respectively (hereinafter the image forming units 222Y to 222K), an intermediate transfer belt 224 (an example of an intermediate transfer body) to which the toner images formed at the image forming units 222Y to 222K are transferred, first transfer rollers 226 (an example of a first transfer device) that transfer the toner images formed at the image forming units 222Y to 222K to the intermediate transfer belt 224, and a second transfer roller 228 (an example of a second transfer device) that transfers the toner images on the intermediate transfer belt 224, transferred there by the first transfer rollers 226, from the intermediate transfer belt 224 to the recording paper P.

In the illustrated example, the unit formed by the intermediate transfer belt 224, first transfer rollers 226, and second transfer roller 228 corresponds to an example of the transfer devices.

It should be noted that the image forming section 214 is not limited to this configuration; the image forming section 214 may be in other configurations as long as it forms an image on the recording paper P.

The image forming units 222Y to 222K are arranged in a row in the middle of the image forming apparatus 210 in the vertical direction, inclined with respect to the horizontal direction. The image forming units 222Y to 222K, furthermore, each have a photoreceptor 232 (an example of an image carrier) that rotates in one direction (e.g., clockwise in FIG. 1). The image forming units 222Y to 222K are configured in the same manner; in FIG. 1, therefore, the components of the image forming units 222M, 222C, and 222K are illustrated without reference signs.

Around each photoreceptor 232, there are a charging device 223 having a charging roller 223A with which it charges the photoreceptor 232, an exposure device 236 (an example of an electrostatic charge image creating device) that exposes the photoreceptor 232 charged by the charging device 223 to light to create an electrostatic charge image on the photoreceptor 232, a developing device 238 that develops the electrostatic charge image created on the photoreceptor 232 by the exposure device 236 to form a toner image, and a photoreceptor cleaner 240 that cleans off residual toner on the photoreceptor 232.

In the illustrated example, the photoreceptor 232, charging device 223, exposure device 236, developing device 238, and photoreceptor cleaner 240 are held together in a housing (enclosure) 222A, forming a cartridge (process cartridge).

The exposure device 236 is a self-scanning LED printhead. Alternatively, the exposure device 236 may be an optical exposure device that directs light from a light source onto the photoreceptor 232 via a polygon mirror.

The exposure device 236 is configured to create an electrostatic charge image based on an image signal transmitted from the controller 220. An example of an image signal transmitted from the controller 220 is an image signal that the controller 220 acquires from an external device.

The developing device 238 includes a developing roller 238A (an example of a developer carrier) that retains a developer on its surface and develops the electrostatic charge image created on the photoreceptor 232 into a toner image by supplying the developer to the photoreceptor 232 and multiple transport members 238B that transport the developer to be attached to the developing roller 238A while stirring it.

The photoreceptor cleaner 240 has a blade 240A that is in contact with the photoreceptor 232 and cleans off residual toner on the photoreceptor 232.

The intermediate transfer belt 224 is shaped like a ring and is positioned above the image forming units 222Y to 222K. Inside the intermediate transfer belt 224, there are wrapping rollers 242, 244, and 328 around which the intermediate transfer belt 224 is wrapped. The intermediate transfer belt 224 is configured to circulate (rotate) in one direction (e.g., counterclockwise in FIG. 1) while in contact with the photoreceptors 232 as a result of the rotation of any of the wrapping rollers 242, 244, and 328. The wrapping roller 242 is configured as a “facing roller,” a roller that faces the second transfer roller 228.

The first transfer rollers 226 face the photoreceptors 232 with the intermediate transfer belt 224 interposed therebetween. The points between the first transfer rollers 226 and the photoreceptors 232 are designated as the first transfer points, at which the toner images formed on the photoreceptors 232 are transferred to the intermediate transfer belt 224.

The second transfer roller 228 faces the wrapping roller 242 with the intermediate transfer belt 224 interposed therebetween. The point between the second transfer roller 228 and the wrapping roller 242 is designated as the second transfer point, at which the toner images transferred to the intermediate transfer belt 224 are transferred to the recording paper P.

The transport section 216 includes a pickup roller 246 that retrieves and sends out the recording paper P stored in the container section 212, a transport path 248 along which the recording paper P sent out by the pickup roller 246 is transported, and multiple transport rollers 250 that are positioned along the transport path 248 and transport the recording paper P sent out by the pickup roller 246 to the second transfer point.

Downstream of the second transfer point in the direction of transport, there is a fixing device 260 that fixes the toner image formed on the recording paper P by the image forming section 214 onto the recording paper P.

The fixing device 260 includes a heating roller 264 that heats the image on the recording paper P and a pressure roller 266 as an example of a pressurizing member. Inside the heating roller 264 is a heat source 264B.

Downstream of the fixing device 260 in the direction of transport, there are ejection rollers 252 that eject the recording paper P with the fixed toner image thereon to the ejection section 218.

### Heating Devices for the Toner Image and Recording Paper

The image forming apparatus 210 includes a first heating roller 270 (an example of a first heating device) that heats the toner images transferred to the surface of the intermediate transfer belt 224 before the second transfer roller 228 transfers the toner images to the surface of the recording paper P. The first heating roller 270 is disposed, for example, inside the intermediate transfer belt 224, with or without making contact with the inner surface of the belt, and heats the toner images with the intermediate transfer belt 224 mediating therebetween. Alternatively, the first heating roller 270 may be disposed outside the intermediate transfer belt 224 without making contact with the outer surface of the belt and heat the toner images directly.

The temperature to which the toner images are heated by the first heating roller 270 may be 40° C. or above and 70° C. or below, preferably 50° C. or above and 65° C. or below.

Setting the heating temperature for the toner images within these ranges may help reduce the water content of the toner with limited melting of the toner. As a result, the likelihood of reduced image density unevenness may increase.

In addition, the image forming apparatus 210 includes second heating rollers 272 (an example of a second heating device) that heat the recording paper P before the second transfer roller 228 transfers the toner images to the surface of the recording paper P. The second heating rollers 272 are disposed in the transport path for the recording paper P in such a manner that they come into contact with one or both sides of the recording paper P or that they do not, and heat the recording paper P directly. In FIG. 1, a pair of second heating rollers 272 that heat both sides of the recording paper P are illustrated.

The temperature to which the recording paper P is heated by the second heating rollers 272 may be 40° C. or above and 70° C. or below, preferably 50° C. or above and 65° C. or below.

Setting the heating temperature for the recording paper P within these ranges may help reduce the water content of the recording paper P with limited cockling of the paper caused by abrupt water evaporation. As a result, the likelihood of reduced image density unevenness may increase.

The first heating roller 270 and the second heating rollers 272 can be, for example, heating rollers having a built-in heat source, such as a halogen lamp or heating wire.

It should be noted that the first heating device and the second heating device are not limited to the first heating roller 270 and the second heating rollers 272; known heating devices, such as plane heaters, can be used.

In certain configurations, the first heating device may be a device that heats the toner images using heat generated from the fixing device 260 (specifically, the heating roller 264), and the second heating device may be a device that heats the recording paper P using heat generated from the fixing device 260 (specifically, the heating roller 264). A specific example of such a configuration is as follows.

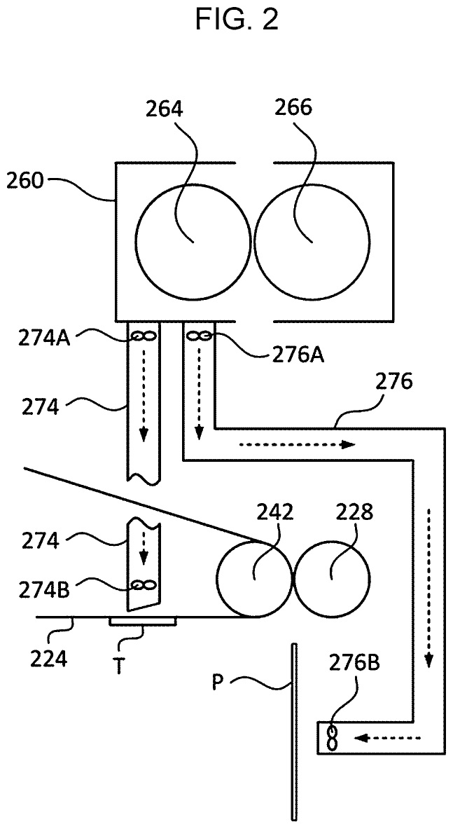

As illustrated in FIG. 2, as an example of a first heating device, a first duct 274 is installed for air heated at the fixing device 260 (specifically, the heating roller 264) to be sent through from the fixing device 260 to the inside of the intermediate transfer belt 224. Inside the first duct 274, an intake fan 274A is disposed closer to the fixing device 260, and an exhaust fan 274B is disposed closer to the intermediate transfer belt 224. As the fans operate, air heated at the fixing device 260 is delivered to the inner surface of the intermediate transfer belt 224 through the first duct 274, and the toner images are heated by this air, mediated by the intermediate transfer belt 224.

In addition, as an example of a second heating device, a second duct 276 is installed for air heated at the fixing device 260 (specifically, the heating roller 264) to be sent through from the fixing device 260 to the transport path for the recording paper P. Inside the second duct 276, an intake fan 276A is disposed closer to the fixing device 260, and an exhaust fan 276B is disposed closer to the transport path for the recording paper P. As the fans operate, air heated at the fixing device 260 is delivered to the transport path for the recording paper P through the second duct 276, and the recording paper P passing through the transport path is heated by this air.

In configurations in which heat generated from the fixing device 260 is used to heat the toner images and recording paper, the adjustment of the heating temperatures can be achieved by, for example, the method of providing a separate duct for air intake from outside the fixing device within the route of each duct or the method of modifying the length of the ducts.

Heating the toner images and recording paper using heat generated from the fixing device 260 may help reduce image density unevenness in high-temperature and high-humidity environments at low cost compared with configurations involving separate heat sources, such as heating rollers.

Incidentally, the heating temperatures for the toner images and the recording paper may be such that the temperatures of the toner images and the recording paper when they reach the second transfer member will be 40° C. or above and 70° C. or below.

In addition, the first duct 274 and the second duct 276 may be partially integrated near the fixing device 260.

In FIG. 2, a toner image T, the second transfer roller 228, a wrapping roller 242, the heating roller 264, and the pressure roller 266 are also illustrated.

### Operation of the Image Forming Apparatus

An example of an operation of the image forming apparatus 210 according to this exemplary embodiment will be described. The operations of the image forming apparatus 210 are conducted through control programs run at the controller 220.

First, in the image forming apparatus 210, recording paper P retrieved and sent out from the container section 212 by the pickup roller 246 is delivered to the second transfer point by the multiple transport rollers 250.

Before reaching the second transfer point, the recording paper P is heated by the second heating rollers 272.

Meanwhile, at the image forming units 222Y to 222K, the photoreceptor 232 charged by the charging device 223 is exposed to light by the exposure device 236, resulting in the creation of an electrostatic charge image on the photoreceptor 232. This electrostatic charge image is developed by the developing device 238, forming a toner image on the photoreceptor 232. The toner images in their respective colors formed at the image forming units 222Y to 222K are layered on the intermediate transfer belt 224 at the first transfer points, producing a color image. Then the color image produced on the intermediate transfer belt 224 is transferred to the recording paper P at the second transfer point.

Before reaching the second transfer point, the color image (i.e., toner images) produced on the intermediate transfer belt 224 is heated by the first heating roller 270.

The recording paper P with the transferred toner images thereon is transported to the fixing device 260, and the transferred toner images are fixed by the fixing device 260. The recording paper P with the fixed toner images thereon is ejected to the ejection section 218 by the ejection rollers 252. In such a manner, a series of image forming operations is performed.

### Electrostatic Charge Image Developer

The electrostatic charge image developer housed in the developing device in the image forming apparatus according to this exemplary embodiment (hereinafter also referred to as “the electrostatic charge image developer according to this exemplary embodiment”) will now be described.

The electrostatic charge image developer according to this exemplary embodiment contains at least toner.

The electrostatic charge image developer according to this exemplary embodiment may be a one-component developer, which consists substantially of toner, or may be a two-component developer, which contains toner and a carrier.

The toner contains toner particles. The toner may contain toner particles and external additives.

The toner will now be described in detail.

### Toner Particles

The toner particles contain, for example, at least one binder resin. The toner particles may contain at least one coloring agent, a release agent, resin particles, and additives.

The toner particles may contain at least one binder resin and resin particles in particular. Toner particles in this composition are likely to cause image density unevenness due to their tendency to retain water in high-temperature and high-humidity environments.

With the image forming apparatus according to this exemplary embodiment, however, image density unevenness may be reduced even when toner particles containing one or more binder resins and resin particles are employed.

### Binder Resin

Examples of binder resins include vinyl resins that are homopolymers of monomers such as styrenes (e.g., styrene, para-chlorostyrene, and α-methylstyrene), (meth)acrylates (e.g., methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (e.g., acrylonitrile and methacrylonitrile), vinyl ethers (e.g., vinyl methyl ether and vinyl isobutyl ether), vinyl ketones (e.g., vinyl methyl ketone, vinyl ethyl ketone, and vinyl isopropenyl ketone), and olefins (e.g., ethylene, propylene, and butadiene) and copolymers of two or more such monomers.

Non-vinyl resins, such as epoxy resins, polyester resins, polyurethane resins, polyamide resins, cellulose resins, polyether resins, and modified rosin, mixtures of such a non-vinyl resin and a vinyl resin, and graft copolymers obtained by polymerizing a vinyl monomer in the presence of such a non-vinyl resin are also examples of binder resins.

One such binder resin may be used alone, or two or more may be used in combination.

The binder resin may be a polyester resin.

Examples of polyester resins include known amorphous polyester resins. A combination of an amorphous polyester resin and a crystalline polyester resin may also be used. In that case, the amount of crystalline polyester resin used may be 2% by mass or more and 40% by mass or less (preferably 2% by mass or more and 20% by mass or less) of all binder resins.

It should be noted that when a resin is described as “crystalline,” it means that its differential scanning calorimetry (DSC) profile exhibits a clear endothermic peak rather than a stairstep change in heat absorption; specifically, it means that the half width of the endothermic peak as measured at a heating rate of 10 (° C./min) is 10° C. or less.

When a resin is described as “amorphous,” by contrast, it means that the half width exceeds 10° C., a stairstep change in heat absorption is present, or no clear endothermic peak is observed.

### Amorphous Polyester Resin

An example of an amorphous polyester resin is a polycondensate of at least one polycarboxylic acid and at least one polyhydric alcohol. The amorphous polyester resin may be a commercially available one or may be a synthesized one.

Examples of polycarboxylic acids include aliphatic dicarboxylic acids (e.g., oxalic acid, malonic acid, maleic acid, fumaric acid, citraconic acid, itaconic acid, glutaconic acid, succinic acid, alkenylsuccinic acids, adipic acid, and sebacic acid), alicyclic dicarboxylic acids (e.g., cyclohexanedicarboxylic acid), aromatic dicarboxylic acids (e.g., terephthalic acid, isophthalic acid, orthophthalic acid, and naphthalenedicarboxylic acid), and anhydrides or lower-alkyl (e.g., C1 to C5 alkyl) esters thereof. Of these, aromatic dicarboxylic acids, for example, are preferred polycarboxylic acids.

The polycarboxylic acid may be a combination of a dicarboxylic acid with a carboxylic acid that has three or more carboxylic groups and can take a crosslinked or branched structure. Examples of carboxylic acids having three or more carboxylic groups include trimellitic acid, pyromellitic acid, and anhydrides or lower-alkyl (e.g., C1 to C5 alkyl) esters thereof.

One polycarboxylic acid may be used alone, or two or more may be used in combination.

Examples of polyhydric alcohols include aliphatic diols (e.g., ethylene glycol, diethylene glycol, triethylene glycol, propylene glycol, butanediol, hexanediol, and neopentyl glycol), alicyclic diols (e.g., cyclohexanediol, cyclohexanedimethanol, and hydrogenated bisphenol A), and aromatic diols (e.g., ethylene oxide adducts of bisphenol A and propylene oxide adducts of bisphenol A). Of these, aromatic diols and alicyclic diols, for example, are preferred polyhydric alcohols, and aromatic diols are more preferred polyhydric alcohols.

The polyhydric alcohol may be a combination of a diol with a polyhydric alcohol that has three or more hydroxyl groups and can take a crosslinked or branched structure. Examples of polyhydric alcohols having three or more hydroxyl groups include glycerol, trimethylolpropane, and pentaerythritol.

One polyhydric alcohol may be used alone, or two or more may be used in combination.

The glass transition temperature (Tg) of the amorphous polyester resin may be 50° C. or above and 80° C. or below, preferably 50° C. or more and 65° C. or below.

The glass transition temperature is determined from a DSC curve obtained by differential scanning calorimetry (DSC); more specifically, it is determined as an extrapolated glass transition starting temperature as described in the methods for determining glass transition temperatures in JIS K 7121-1987, “Testing Methods for Transition Temperatures of Plastics.”

The weight-average molecular weight (Mw) of the amorphous polyester resin may be 5000 or more and 1000000 or less, preferably 7000 or more and 500000 or less.

The number-average molecular weight (Mn) of the amorphous polyester resin may be 2000 or more and 100000 or less.

The molecular weight distribution, Mw/Mn, of the amorphous polyester resin may be 1.5 or greater and 100 or less, preferably 2 or greater and 60 or less.

The weight-average and number-average molecular weights are measured by gel permeation chromatography (GPC). The molecular weight measurements by GPC are performed using HLC-8120 GPC, a GPC manufactured by Tosoh Corporation, as the measuring instrument and TSKgel SuperHM-M (15 cm), a column manufactured by Tosoh Corporation, with THF eluent. The weight-average and number-average molecular weights are calculated based on the results of these measurements using molecular-weight calibration curves constructed using monodisperse polystyrene standards.

The amorphous polyester resin can be obtained by a known production method. Specifically, it can be obtained by the method of allowing the starting monomers to react while removing the water and alcohol produced during condensation, optionally reducing the pressure inside the reaction system, with the polymerization temperature set to 180° C. or above and 230° C. or below.

When the raw-material monomers are insoluble or immiscible at the reaction temperature, a high-boiling solvent may be added as a solubilizer to facilitate dissolution. In that case, the solubilizer is distilled away during the polycondensation. When there is an immiscible monomer, it may be condensed beforehand with the acid or alcohol planned to be polycondensed with it before proceeding to polycondensation.

### Crystalline Polyester Resin

An example of a crystalline polyester resin is a polycondensate of at least one polycarboxylic acid and at least one polyhydric alcohol. The crystalline polyester resin may be a commercially available one or may be a synthesized one.

The crystalline polyester resin may be a polycondensate made with linear aliphatic polymerizable monomers rather than aromatic polymerizable monomers; this may allow the resin to form a crystal structure more easily.

Examples of polycarboxylic acids include aliphatic dicarboxylic acids (e.g., oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (e.g., dibasic acids, such as phthalic acid, isophthalic acid, terephthalic acid, and naphthalene-2,6-dicarboxylic acid), and anhydrides or lower-alkyl (e.g., C1 to C5 alkyl) esters thereof.

The polycarboxylic acid may be a combination of a dicarboxylic acid with a carboxylic acid that has three or more carboxylic groups and can take a crosslinked or branched structure. Examples of carboxylic acids having three carboxylic groups include aromatic carboxylic acids (e.g., 1,2,3-benzenetricarboxylic acid, 1,2,4-benzenetricarboxylic acid, and 1,2,4-naphthalenetricarboxylic acid) and anhydrides or lower-alkyl (e.g., C1 to C5 alkyl) esters thereof.

The polycarboxylic acid may be a combination of a dicarboxylic acid with a dicarboxylic acid having a sulfonic acid group or ethylenic double bond.

One polycarboxylic acid may be used alone, or two or more may be used in combination.

Examples of polyhydric alcohols include aliphatic diols (e.g., linear aliphatic diols having a C7 to C20 backbone). Examples of aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol. Of these, 1,8-octanediol, 1,9-nonanediol, and 1,10-decanediol are preferred aliphatic diols.

The polyhydric alcohol may be a combination of a diol with an alcohol that has three or more hydroxyl groups and can take a crosslinked or branched structure. Examples of alcohols having three or more hydroxyl groups include glycerol, trimethylolethane, trimethylolpropane, and pentaerythritol.

One polyhydric alcohol may be used alone, or two or more may be used in combination.

For the polyhydric alcohol, the amount of aliphatic diols may be 80 mol % or more, preferably 90 mol % or more.

The melting temperature of the crystalline polyester resin may be 50° C. or above and 100° C. or below, preferably 55° C. or above and 90° C. or below, more preferably 60° C. or above and 85° C. or below.

The melting temperature is determined from a DSC curve obtained by differential scanning calorimetry (DSC), as the peak melting temperature described in the methods for determining melting temperatures set forth in JIS K7121-1987 “Testing Methods for Transition Temperatures of Plastics.”

The weight-average molecular weight (Mw) of the crystalline polyester resin may be 6,000 or more and 35,000 or less.

The crystalline polyester resin can be obtained by a known production method; for example, it can be obtained in the same manner as the amorphous polyester resin.

The amount of the binder resin may be, for example, 40% by mass or more and 95% by mass or less, preferably 50% by mass or more and 90% by mass or less, more preferably 60% by mass or more and 85% by mass or less of the toner particles as a whole.

### Coloring Agent

Examples of coloring agents include various pigments, such as carbon black, chrome yellow, Hansa yellow, benzidine yellow, threne yellow, quinoline yellow, pigment yellow, permanent orange GTR, pyrazolone orange, Vulcan orange, Watchung red, permanent red, brilliant carmine 3B, brilliant carmine 6B, DuPont oil red, pyrazolone red, lithol red, rhodamine B lake, lake red C, pigment red, rose bengal, aniline blue, ultramarine blue, Calco oil blue, methylene blue chloride, phthalocyanine blue, pigment blue, phthalocyanine green, and malachite green oxalate, and types of dyes, such as acridine, xanthene, azo, benzoquinone, azine, anthraquinone, thioindigo, dioxazine, thiazine, azomethine, indigo, phthalocyanine, aniline black, polymethine, triphenylmethane, diphenylmethane, and thiazole dyes.

One coloring agent may be used alone, or two or more may be used in combination.

The coloring agent may optionally be a surface-treated coloring agent and may be used in combination with a dispersant. Multiple types of coloring agents, furthermore, may be used in combination.

The amount of the coloring agent may be 1% by mass or more and 30% by mass or less, preferably 3% by mass or more and 15% by mass or less, of the toner particles as a whole.

### Release Agent

Examples of release agents include hydrocarbon waxes; natural waxes, such as carnauba wax, rice bran wax, and candelilla wax; synthesized or mineral/petroleum waxes, such as montan wax; and ester waxes, such as fatty acid esters and montanates. Release agents that can be used are not limited to these.

The melting temperature of the release agent may be 50° C. or above and 110° C. or below, preferably 60° C. or above and 100° C. or below.

The melting temperature is determined from a DSC curve obtained by differential scanning calorimetry (DSC), as the peak melting temperature described in the methods for determining melting temperatures set forth in JIS K 7121-1987 “Testing Methods for Transition Temperatures of Plastics.”

The amount of the release agent may be 1% by mass or more and 20% by mass or less, preferably 5% by mass or more and 15% by mass or less, of the toner particles as a whole.

### Resin Particles

Examples of resin particles include particles of resins such as polyolefin resins (e.g., polyethylene and polypropylene), styrene resins (e.g., polystyrene and α-polymethylstyrene), (meth)acrylic resins (e.g., polymethyl methacrylate and polyacrylonitrile), epoxy resins, polyurethane resins, polyurea resins, polyamide resins, polycarbonate resins, polyether resins, polyester resins, and their copolymeric resins.

The resin particles may be styrene-(meth)acrylic copolymeric resin particles.

An example of styrene-(meth)acrylic copolymeric resin particles is particles of a resin obtained by polymerizing a styrene monomer and a (meth)acrylic acid monomer through radical polymerization.

Examples of styrene monomers include styrene, α-methylstyrene, and vinylnaphthalene, alkylated styrenes, or styrenes having an alkyl chain, such as 2-methylstyrene, 3-methylstyrene, 4-methylstyrene, 2-ethylstyrene, 3-ethylstyrene, and 4-ethylstyrene, halogenated styrenes, such as 2-chlorostyrene, 3-chlorostyrene, and 4-chlorostyrene, and fluorinated styrenes, such as 4-fluorostyrene and 2,5-difluorostyrene. Of these, styrene and α-methylstyrene are preferred styrene monomers.

Examples of (meth)acrylic acid monomers include (meth)acrylic acid, n-methyl (meth)acrylate, n-ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, phenyl (meth)acrylate, biphenyl (meth)acrylate, diphenylethyl (meth)acrylate, t-butylphenyl (meth)acrylate, terphenyl (meth)acrylate, cyclohexyl (meth)acrylate, t-butylcyclohexyl (meth)acrylate, dimethylaminoethyl (meth)acrylate, diethylaminoethyl (meth)acrylate, methoxyethyl (meth)acrylate, 2-hydroxyethyl (meth)acrylate, β-carboxyethyl (meth)acrylate, (meth)acrylonitrile, and (meth)acrylamide. Of these, n-butyl (meth)acrylate and β-carboxyethyl (meth)acrylate are preferred (meth)acrylic acid monomers.

The resin particles may be crosslinked resin particles. Examples of crosslinkers used to crosslink the resin in crosslinked resin particles include aromatic polyvinyl compounds, such as divinylbenzene and divinylnaphthalene; polyvinyl esters of aromatic polycarboxylic acids, such as divinyl phthalate, divinyl isophthalate, divinyl terephthalate, divinyl homophthalate, divinyl trimesate, trivinyl trimesate, divinyl naphthalenedicarboxylate, and divinyl biphenylcarboxylate; divinyl esters of nitrogen-containing aromatic compounds, such as divinyl pyridinedicarboxylate; vinyl esters of unsaturated heterocyclic carboxylic acid compounds, such as vinyl pyromucate, vinyl furancarboxylate, vinyl pyrrole-2-carboxylate, and vinyl thiophenecarboxylate; (meth)acrylates of linear-chain polyhydric alcohols, such as butanediol diacrylate, butanediol methacrylate, hexanediol acrylate, octanediol methacrylate, decanediol acrylate, and dodecanediol methacrylate; (meth)acrylates of branched or substituted polyhydric alcohols, such as neopentyl glycol dimethacrylate and 2-hydroxy-1,3-diacryloxypropane; polyethylene glycol di(meth)acrylates and polypropylene polyethylene glycol di(meth)acrylates, and polyvinyl esters of polycarboxylic acids, such as divinyl succinate, divinyl fumarate, vinyl maleate, divinyl maleate, divinyl diglycolate, vinyl itaconate, divinyl itaconate, divinyl acetonedicarboxylate, divinyl glutarate, divinyl 3,3′-thiodipropionate, divinyl trans-aconitate, trivinyl trans-aconitate, divinyl adipate, divinyl pimelate, divinyl suberate, divinyl azelate, divinyl sebacate, divinyl dodecanedioate, and divinyl brassylate. One crosslinker may be used alone, or two or more may be used in combination.

An example of resin particles with which the toner is likely to experience a hygroscopic increase in water content in high-temperature and high-humidity environments is (meth)acrylic acid resin particles.

Examples of (meth)acrylic acid resin particles include homopolymer resin particles, which consist substantially of a (meth)acrylic acid monomer, and copolymeric resin particles formed by a styrene monomer and a (meth)acrylic acid monomer.

Examples of homopolymer resin particles, consisting substantially of a (meth)acrylic acid monomer, include particles of polymethyl methacrylate, polyethyl acrylate, and other homopolymers of monomers.

An example of copolymeric resin particles formed by a styrene monomer and a (meth)acrylic acid monomer is particles of a copolymeric resin in which the styrene monomer is styrene, the (meth)acrylic acid monomer is n-butyl acrylate, and the ratio by mass between the styrene monomer and the (meth)acrylic acid monomer (the styrene monomer/the (meth)acrylic acid monomer) is 10/90 or greater and 70/30 or less (preferably 20/80 or greater and 65/35 or less).

When the (meth)acrylic acid resin particles are crosslinked resin particles made using a crosslinker, furthermore, the crosslinker may be a bifunctional alkyl acrylate having a C6 to C12 alkylene group, and the amount of the crosslinker may be, for example, 0.3 parts by mass or more and 5.0 parts by mass or less, preferably 0.5 parts by mass or more and 2.5 parts by mass or less, more preferably 1.0 part by mass or more and 2.0 parts by mass or less per a total of 100 parts by mass of the styrene monomer, (meth)acrylic acid monomer, and crosslinker.

With the image forming apparatus according to this exemplary embodiment, image density unevenness may be reduced even when toner particles containing such resin particles, and thus prone to experience a hygroscopic increase in water content in high-temperature and high-humidity environments, are employed.

The average primary particle diameter of the resin particles may be 20 nm or more and 500 nm or less, preferably 30 nm or more and 300 nm or less, more preferably 50 nm or more and 250 nm or less.

When the average primary particle diameter of the resin particles falls within these ranges, the resin particles may be unlikely to aggregate inside the toner particles, and this may encourage the presence of resin particles in an adequate size. It may, therefore, be unlikely that the resin particles form conductive paths, and image density unevenness caused by water absorption by the toner particles may be reduced in high-temperature and high-humidity environments.

The average primary particle diameter of the resin particles is a value measured using a transmission electron microscope (TEM).

An example of a transmission electron microscope that can be used is JEM-2100Plus, manufactured by JEOL Ltd.

Specifically, the method for measuring the average primary particle diameter of the resin particles is as follows.

A toner particle is cut to a thickness of approximately 0.1 μm using a microtome. The cross-section of the toner particle is imaged with a transmission electron microscope at a magnification of 10000, the equivalent circular diameter is calculated for 100 resin particles dispersed in the toner particle from their respective cross-sectional areas, and the arithmetic mean of the equivalent circular diameters is reported as the average primary particle diameter.

The amount of the resin particles may be 2% by mass or more and 30% by mass or less, preferably 3% by mass or more and 25% by mass or less, more preferably 5% by mass or more and 20% by mass or less of the toner particles.

Toner particles containing such an amount of resin particles are likely to cause image density unevenness because of their tendency to retain water in high-temperature and high-humidity environments.

With the image forming apparatus according to this exemplary embodiment, however, image density unevenness may be reduced even when toner particles containing one or more binder resins and resin particles are employed.

### Additives

Examples of additives include known additives, such as magnetic substances, charge control agents, and inorganic powders. Such additives are contained in the toner particles as internal additives.

### Characteristics and Other Details of the Toner Particles

The toner particles may be toner particles in a single-layer structure or may be toner particles in a so-called core-shell structure, i.e., toner particles composed of a core portion (core particle) and a coating layer covering the core portion (shell layer).

The toner particles in a core-shell structure may be composed of, for example, a core portion containing a binder resin and optionally additives, such as a coloring agent and a release agent, and a coating layer containing a binder resin.

The volume-average particle diameter (D50v) of the toner particles may be 2 μm or more and 10 μm or less, preferably 4 μm or more and 8 μm or less.

Average particle diameters and geometric standard deviations of the toner particles are measured using Coulter Multisizer II (manufactured by Beckman Coulter, Inc.) with the electrolyte being ISOTON-II (manufactured by Beckman Coulter, Inc.).

As preparation for the measurement, a measurement sample weighing 0.5 mg or more and 50 mg or less is put into 2 ml of a 5% aqueous solution of a surfactant (e.g., a sodium alkylbenzene sulfonate) as a dispersant. The resulting mixture is added to 100 ml or more and 150 ml or less of the electrolyte.

The electrolyte with the suspended sample therein is subjected to dispersion treatment for 1 minute using a sonicator, and the particle size distribution of particles falling within a diameter range of 2 μm to 60 μm is measured using Coulter Multisizer II with an aperture size of 100 μm. The number of particles sampled is 50000.

Cumulative distributions are drawn by plotting the volume and the number of particles, each from the smallest diameter, against segments by particle size (channels) divided based on the measured particle size distribution, and the particle diameters at which the cumulative percentage is 16% are defined as volume-based particle diameter D16v and number-based particle diameter D16p, the particle diameters at which the cumulative percentage is 50% are defined as the volume-average particle diameter D50v and the cumulative number-average particle diameter D50p, and the particle diameters at which the cumulative percentage is 84% are defined as volume-based particle diameter D84v and number-based particle diameter D84p.

Using these, the geometric standard deviation by volume (GSDv) is calculated as (D84v/D16v)^{1/2}, and the geometric standard deviation by number (GSDp) is calculated as (D84p/D16p)^{1/2}.

The average circularity of the toner particles may be 0.90 or greater and 1.00 or less, preferably 0.92 or greater and 0.98 or less.

The average circularity of the toner particles is given by (circumference of the equivalent circle)/(circumference) [(circumference of a circle having the same projected area as the particle's image)/(circumference of the particle's projected image)]. Specifically, it is a value measured by the following method.

First, the toner particles of interest are sampled by aspiration in such a manner that the sample will form a flat stream, and this flat stream is photographed with a flash to capture the figures of the particles in a still image; then the average circularity is determined by analyzing the particle images using a flow particle-image analyzer (FPIA-3000, manufactured by Sysmex Corporation). The number of particles sampled in determining the average circularity is 3500.

When the toner contains external additives, the toner (developer) of interest is dispersed in water containing a surfactant, and then the resulting dispersion is sonicated to give toner particles from which the external additives have been removed.

### External Additives

An example of an external additive is inorganic particles. Examples of the inorganic particles include particles of SiO₂, TiO₂, Al₂O₃, SrTiO₃, CuO, ZnO, SnO₂, CeO₂, Fe₂O₃, MgO, BaO, CaO, K₂O, Na₂O, ZrO₂, CaO·SiO₂, K₂O. (TiO₂)ₙ, Al₂O₃·2SiO₂, CaCO₃, MgCO₃, BaSO₄, and MgSO₄.

The surface of the inorganic particles as an external additive may have undergone hydrophobization treatment. The hydrophobization treatment is performed by, for example, immersing the inorganic particles in at least one hydrophobizing agent. The hydrophobizing agent is not particularly limited, but examples include silane coupling agents, silicone oils, titanate coupling agents, and aluminum coupling agents. One such hydrophobizing agent may be used alone, or two or more may be used in combination.

The amount of the hydrophobizing agent is typically 1 part by mass or more and 10 parts by mass or less, for example, per 100 parts by mass of the inorganic particles.

Examples of external additives also include resin particles (particles of, for example, polystyrene, polymethyl methacrylate (PMMA), or melamine resin) and active cleaning agents (e.g., metal salts of higher fatty acids, typically zinc stearate, and particles of fluoropolymers).

The amount of external additives added may be, for example, 0.01% by mass or more and 10% by mass or less, preferably 0.01% by mass or more and 6.0% by mass or less, of the toner particles.

### Method for Producing the Toner

A method for producing the toner according to this exemplary embodiment will now be described.

The toner according to this exemplary embodiment can be obtained by producing the toner particles and then adding external additives to the toner particles.

The toner particles may be produced by either a dry process (e.g., kneading and milling) or a wet process (e.g., aggregation and coalescence, suspension polymerization, or dissolution and suspension). The production process for the toner particles is not particularly limited to these; known processes can be used.

Of these, the toner particles may be obtained by aggregation and coalescence in particular.

Specifically, when the toner particles are produced by, for example, aggregation and coalescence, the toner particles are produced through, for instance:
a step of mixing a first resin particle dispersion, in which first resin particles precursory to a binder resin are dispersed, a coloring agent dispersion, in which a coloring agent is dispersed, and a release agent particle dispersion, in which particles of a release agent (hereinafter also referred to as “release agent particles”) are dispersed, and causing the particles and the coloring agent to aggregate in the resulting dispersion to form first aggregates (first aggregate formation step);
a step of adding second resin particles precursory to a binder resin to the resulting first aggregate dispersion, in which the first aggregates are dispersed, and causing the second resin particles to aggregate on the surface of the first aggregates to form second aggregates (second aggregate formation step); and
a step of heating the second aggregate dispersion, in which the second aggregates are dispersed, to cause the second aggregates to fuse and coalesce and thereby to form toner particles (fusion and coalescence step).

It should be noted that although this aggregation and coalescence process is described as a production process for toner particles containing a binder resin, a coloring agent, and a release agent, the coloring agent and the release agent are ingredients that are optionally incorporated into the toner particles.

The details of the individual steps will now be described.

### Dispersion Preparation Step

First, the individual dispersions to be used in the aggregation and coalescence process are prepared. Specifically, a first resin particle dispersion, in which first resin particles precursory to a binder resin are dispersed, a coloring agent dispersion, in which a coloring agent is dispersed, a second resin particle dispersion, in which second resin particles precursory to a binder resin are dispersed, and a release agent particle dispersion, in which release agent particles are dispersed, are prepared.

In the description of the dispersion preparation step, the first resin particles and the second resin particles are referred to as “resin particles.”

The resin particle dispersions are prepared by, for example, dispersing the resin particles in at least one dispersion medium with at least one surfactant.

An example of a dispersion medium used in the resin particle dispersions is an aqueous medium.

Examples of aqueous media include types of water, such as distilled water and deionized water, and alcohols. One such medium may be used alone, or two or more may be used in combination.

Examples of surfactants include anionic surfactants, such as salts of sulfates, salts of sulfonic acid, esters of phosphoric acid, and soap surfactants; cationic surfactants, such as amine salts and quaternary ammonium salts; and nonionic surfactants, such as polyethylene glycol surfactants, ethylene oxide adducts of alkylphenols, and polyhydric alcohols. In particular, anionic surfactants and cationic surfactants are typical examples. Nonionic surfactants may be used in combination with an anionic or cationic surfactant.

One surfactant may be used alone, or two or more may be used in combination.

In the context of the resin particle dispersions, examples of methods for dispersing the resin particles in the dispersion medium include common dispersion methods, such as a rotary-shear homogenizer and a ball mill, sand mill, Dyno-Mill, and other medium mills. Depending on the type of resin particles, furthermore, the resin particles may be dispersed in the resin particle dispersion by phase inversion emulsification.

Phase inversion emulsification is a method for dispersing particles of a resin in an aqueous medium and involves dissolving the resin to be dispersed in a hydrophobic organic solvent in which the resin is soluble, neutralizing the organic continuous phase (O phase) by adding a base, and then introducing the aqueous medium (W phase) to induce the transformation of the resin from W/O into O/W (so-called phase inversion) and thereby create a discontinuous phase.

The volume-average particle diameters of the resin particles dispersed in the resin particle dispersions may be, for example, 0.01 μm or more and 1 μm or less, preferably 0.08 μm or more and 0.8 μm or less, more preferably 0.1 μm or more and 0.6 μm or less.

The volume-average diameters of the resin particles are measured using a particle size distribution obtained through measurement with a laser-diffraction particle size distribution analyzer (e.g., LA-700, manufactured by HORIBA, Ltd.); the distribution obtained is divided into segments by particle size (channels), a cumulative volume distribution is plotted starting from the smallest diameter, and the particle diameter at which the cumulative percentage is 50% of all particles is reported as the volume-average particle diameter D50v. The volume-average particle diameter of particles in the other dispersions is also measured in the same manner.

The amount of the resin particles contained in the resin particle dispersions may be 5% by mass or more and 50% by mass or less, preferably 10% by mass or more and 40% by mass or less.

In the same manner as the resin particle dispersions, the coloring agent dispersion and the release agent particle dispersion, for example, are also prepared. The descriptions regarding the volume-average particle diameter of the particles, the dispersion medium, the dispersing method, and the amount of the particles given in the context of the resin particle dispersions, therefore, also pertain to the coloring agent dispersed in the coloring agent dispersion and the release agent particles dispersed in the release agent particle dispersion.

### First Aggregate Formation Step

Then the first resin particle dispersion, the coloring agent dispersion, and the release agent particle dispersion are mixed.

In the resulting dispersion mixture, the first resin particles, the coloring agent, and the release agent particles are caused to undergo heteroaggregation, through which first aggregates, which contain the first resin particles, the coloring agent, and the release agent particles, are formed.

Specifically, the first aggregates are formed by, for example, adding a flocculant to the dispersion in which the first resin particle dispersion, the coloring agent dispersion, and the release agent particle dispersion are mixed, adjusting the pH of the dispersion mixture to an acidic level (e.g., a pH of 2 or higher and 5 or lower) at the same time, optionally adding a dispersion stabilizer, and then placing the dispersion mixture at a temperature of 20° C. or above and 50° C. or below to cause the particles dispersed therein to aggregate.

In the first aggregate formation step, the dispersion mixture may be, for example, stirred with a rotary-shear homogenizer, the flocculant may be added at room temperature (e.g., 25° C.) in that state, the pH of the dispersion mixture may be adjusted to an acidic level (e.g., a pH of 2 or higher and 5 or lower), and then the heating may be carried out, optionally after the addition of a dispersion stabilizer.

Examples of flocculants include a surfactant having the opposite polarity to the surfactants contained as dispersants in the dispersion mixture, an inorganic metal salt, and a divalent or higher-valency metal complex. When the flocculant is a metal complex in particular, the amount of surfactant used may be reduced, and charging characteristics may improve.

An additive that forms a complex or similar bond with metal ions in the flocculant may optionally be used. An example of this additive is a chelating agent.

Examples of inorganic metal salts include metal salts such as calcium chloride, calcium nitrate, barium chloride, magnesium chloride, zinc chloride, aluminum chloride, and aluminum sulfate and polymers of inorganic metal salts, such as polyaluminum chloride, polyaluminum hydroxide, and calcium polysulfide.

The chelating agent may be a water-soluble chelating agent. Examples of chelating agents include oxycarboxylic acids, such as tartaric acid, citric acid, and gluconic acid, iminodiacetic acid (IDA), nitrilotriacetic acid (NTA), and ethylenediaminetetraacetic acid (EDTA).

The amount of chelating agent added may be 0.01 parts by mass or more and 5.0 parts by mass or less, preferably 0.1 parts by mass or more and less than 3.0 parts by mass, per 100 parts by mass of the first resin particles.

### Second Aggregate Formation Step

Then, after the first aggregate dispersion, in which the first aggregates are dispersed, is obtained, a second resin particle dispersion, in which second resin particles are dispersed, is added to the first aggregate dispersion.

The second resin particles may be of the same type as the first resin particles or may be a different type.

Thereafter, in the dispersion of the first aggregates and the second resin particles, the second resin particles are caused to aggregate on the surface of the first aggregates. During this, the release agent particle dispersion may also be added so that the second resin particles and the release agent particles will aggregate on the surface of the first aggregates. Specifically, for example, the second resin particle dispersion is added to the first aggregate dispersion at the time when the first aggregates reach the intended particle diameter in the first aggregate formation step, and the resulting mixture is heated at a temperature equal to or lower than the glass transition temperature of the second resin particles.

Then aggregation is terminated by adjusting the pH of the dispersion to a value within the range of, for example, approximately 6.5 to 8.5.

In such a manner, second aggregates, formed by the first aggregates and aggregates of the second resin particles adhering to their surface, are obtained.

### Fusion and Coalescence Step

Then the second aggregate dispersion, in which the second aggregates are dispersed, is heated to a temperature equal to or higher than the glass transition temperature of the first and second resin particles (e.g., equal to or higher than the glass transition temperature of the first and second resin particles plus 10° C. to 30° C.) to cause the second aggregates to fuse and coalesce into toner particles.

Through these steps, toner particles are obtained.

In the aggregation and coalescence process described above, the second aggregate formation step may be omitted; the toner particles may be formed through the fusion and coalescence of the first aggregates. The second aggregate formation step, furthermore, may be repeated multiple times.

After the completion of the fusion and coalescence step, the toner particles formed in the solution are subjected to known washing, solid-liquid separation, and drying steps to give toner particles in their dry state.

In the washing step, sufficient displacement washing with deionized water may be performed for chargeability reasons. There are no specific restrictions on the solid-liquid separation step, but suction filtration or pressure filtration, for example, may be performed for productivity reasons. In the drying step, too, there are no specific restrictions on the method for carrying out it; for productivity reasons, however, lyophilization, flash drying, fluidized drying, or vibrating fluidized drying, for example, may be conducted.

The toner according to this exemplary embodiment is then produced by, for example, adding external additives to the resulting toner particles in their dry state and mixing them. The mixing may be performed using, for example, a V-blender, Henschel mixer, or Lödige mixer. Optionally, coarse particles in the toner may be removed, for example using a vibrating sieve or air-jet sieve.

### Electrostatic Charge Image Developer

The electrostatic charge image developer according to this exemplary embodiment is one that contains at least toner according to this exemplary embodiment.

The electrostatic charge image developer according to this exemplary embodiment may be a one-component developer, which consists substantially of toner according to this exemplary embodiment, or may be a two-component developer, which is a mixture of the toner and a carrier.

There are no specific restrictions on the carrier, and examples include known carriers. Examples of carriers include a coated carrier, which is composed of a core material that is a magnetic powder and at least one coating resin covering its surface; a magnetic powder-dispersed carrier, which is a mixture of at least one matrix resin and a magnetic powder dispersed in it; and a resin-impregnated carrier, which is a porous magnetic powder impregnated with resin.

The magnetic powder-dispersed and resin-impregnated carriers may be carriers composed of a carrier material that is the particles constituting the carrier and a coating resin covering its surface.

Examples of magnetic powders include powders of magnetic metals, such as iron, nickel, and cobalt, and powders of magnetic oxides, such as ferrite and magnetite.

For the coating resin and the matrix resin, examples include styrene-(meth)acrylic acid resins; polyolefin resins, such as polyethylene resins and polypropylene resins; polyvinyl or polyvinylidene resins, such as polystyrene, (meth)acrylic resins, polyacrylonitrile, polyvinyl acetate, polyvinyl alcohol, polyvinyl butyral, polyvinyl chloride, polyvinyl carbazole, polyvinyl ethers, and polyvinyl ketones; vinyl chloride-vinyl acetate copolymers; straight silicone resins, which are formed by organosiloxane bonds, or their modified forms; fluoropolymers, such as polytetrafluoroethylene, polyvinyl fluoride, polyvinylidene fluoride, and polychlorotrifluoroethylene; polyesters; polyurethanes; polycarbonates; amino resins, such as urea-formaldehyde resins; and epoxy resins.

The coating resin and the matrix resin may include a (meth)acrylic resin, preferably with the (meth)acrylic resin constituting 50% by mass or more of the total mass of the resin, more preferably with the (meth)acrylic resin constituting 80% by mass or more of the total mass of the resin.

In particular, the coating resin and the matrix resin may include an alicyclic (meth)acrylic resin as the (meth)acrylic resin.

In addition, additives, such as electrically conductive particles, may be incorporated in the coating resin and the matrix resin.

Examples of electrically conductive particles include particles of metals, such as gold, silver, and copper, and particles of materials like carbon black, titanium oxide, zinc oxide, tin oxide, barium sulfate, aluminum borate, and potassium titanate.

An example of a method for covering the surface of the core material with the coating resin is the method of covering the surface with a coating-layer formation solution, a solution obtained by dissolving the coating resin in an appropriate solvent optionally with additives. The solvent is not particularly limited; it can be selected considering, for example, the type of coating resin used and its suitability for coating.

Specific examples of methods for applying the resin coating include dipping, in which the core material is dipped into the coating-layer formation solution, spraying, in which the coating-layer formation solution is sprayed onto the surface of the core material, fluidized bed coating, in which the coating-layer formation solution is sprayed with the core material suspended in fluidized air, and kneader-coater coating, in which the core material for the carrier and the coating-layer formation solution are mixed in a kneader-coater, and then the solvent is removed.

The mix ratio (ratio by mass) between the toner and the carrier in a two-component developer may be from 1:100 (toner:carrier) to 30:100, preferably from 3:100 to 20:100.

### EXAMPLES

An exemplary embodiment of the present disclosure will now be described more specifically with examples and comparative examples; no exemplary embodiment of the present disclosure, however, is limited to these examples.

### Preparation of Amorphous Resin Particle Dispersion 1

Terephthalic acid: 98 molar parts
Trimellitic anhydride: 2 molar parts
2-mole ethylene oxide adduct of bisphenol A: 20 molar parts
2-mole propylene oxide adduct of bisphenol A: 80 molar parts

These materials are loaded into a reaction vessel equipped with a stirring device, a nitrogen inlet tube, a temperature sensor, and a rectifying column, the temperature is increased to 190° C. over 1 hour, and 1.2 parts of dibutyl tin oxide is added to 100 parts of the above materials. The temperature is increased to 240° C. over 6 hours while the water produced is removed by distillation, dehydration condensation is continued for 3 hours while the temperature is maintained at 240° C., and then the reaction product is cooled.

While in its molten state, the reaction product is transferred to Cavitron CD1010 (manufactured by K.K. Eurotec) at a rate of 100 g per minute. At the same time, a separately prepared aqueous ammonia having a concentration of 0.37% by mass is transferred to the Cavitron CD1010 at a rate of 0.1 liters per minute while heated to 120° C. in a heat exchanger. The Cavitron CD1010 is operated under the conditions of a rotor frequency of 60 Hz and a pressure of 5 kg/cm², giving a resin particle dispersion in which resin particles having a volume-average particle diameter of 160 nm are dispersed. The solids content of the resin particle dispersion is adjusted to 20% by mass by adding deionized water to it, and the resulting dispersion is designated as amorphous resin particle dispersion 1.

### Preparation of a Crystalline Resin Particle Dispersion

Sebacic acid: 202 parts by mass
Ethylene glycol: 62 parts by mass

These materials are loaded into a reaction vessel equipped with a stirring device, a nitrogen inlet tube, a temperature sensor, and a rectifying column, the temperature is increased to 160° C. over 1 hour, and 0.8 parts by mass of dibutyl tin oxide is added. The temperature is increased to 180° C. over 6 hours while the water produced is removed by distillation, and dehydration condensation is continued for 5 hours while the temperature is maintained at 180° C. Then the temperature is gradually increased to 230° C. under reduced pressure, and stirring is performed for 2 hours while the temperature is maintained at 230° C. Thereafter, the reaction product is cooled. After the cooling, solid-liquid separation is carried out, and the solids are dried to give a crystalline polyester resin.
Crystalline polyester resin: 100 parts
Methyl ethyl ketone: 40 parts
Isopropyl alcohol: 30 parts
10% aqueous solution of ammonia: 6 parts

These materials are added to a jacketed 3-liter reactor (manufactured by Tokyo Rikakikai Co., Ltd.; BJ-30N) equipped with a condenser, a thermometer, a water dispenser, and an anchor blade, and the resin is dissolved with mixing by stirring at 100 rpm while the temperature is maintained at 80° C. using a circulating water bath. Then the circulating water bath is set to 50° C., and a total of 400 parts of deionized water kept at 50° C. is added dropwise at a rate of 7 parts by mass/minute to induce phase inversion; an emulsion is obtained. The resulting emulsion, 576 parts by mass, and 500 parts by mass of deionized water are put into a 2-liter recovery flask, and this recovery flask is attached to an evaporator (manufactured by Tokyo Rikakikai Co., Ltd.) equipped with a vacuum control unit, with a trap between the flask and the evaporator. The solvent is removed by rotating the recovery flask in a hot water bath at 60° C. and reducing the pressure to 7 kPa, with care taken to prevent bumping. Then deionized water is added to give a crystalline resin particle dispersion having a solids concentration of 20% by mass.

### Preparation of Styrene (Meth)acrylic Resin Particle Dispersions

### Preparation of Styrene (Meth)acrylic Resin Particle Dispersion 1

Styrene: 47.9 parts
n-Butyl acrylate: 51.8 parts
β-Carboxyethyl acrylate: 0.3 parts
Anionic surfactant (manufactured by The Dow Chemical Company; Dowfax 2A1): 0.8 parts (initial amount)
Butanediol diacrylate: 1.65 parts

An emulsion is produced by mixing these raw materials until dissolution, adding 60 parts of deionized water, and inducing dispersion and emulsification in a flask.

Following that, 1.3 parts of an anionic surfactant (manufactured by The Dow Chemical Company; Dowfax 2A1) is dissolved in 90 parts of deionized water, 1 part of the above emulsion is added into the resulting solution, and then 10 parts of deionized water with 5.4 parts of ammonium persulfate dissolved therein is introduced.

Thereafter, the rest of the emulsion is added over 180 minutes, the inside of the flask is purged with nitrogen, then the solution inside the flask is heated in an oil bath until 65° C. with stirring, emulsion polymerization is continued under the same conditions for 500 minutes, and then the solids content is adjusted to 24.5% by mass; in this manner, styrene (meth)acrylic resin particle dispersion 1 is obtained.

### Preparation of Styrene (Meth)acrylic Resin Particle Dispersions 2 to 5

Styrene (meth)acrylic resin particle dispersions 2 to 5 are obtained in the same manner as styrene (meth)acrylic resin particle dispersion 1, except that the following manufacturing conditions are changed as specified in Table 1.
The amount of styrene
The amount of n-butyl acrylate
The amount of acrylic acid
The amount of β-carboxyethyl acrylate
The total amount of the anionic surfactant (the proportion between the initial amount and the amount added remains the same as that for dispersion 1)
The amount of butanediol diacrylate (crosslinker in the table)
The amount of ammonium persulfate
Target temperature for heating in an oil bath (polymerization temperature in the table)
Duration of the addition of the rest of the emulsion (duration of addition in the table)
Duration of continued emulsion polymerization after heating (retention time in the table)

### Preparation of a Coloring Agent Dispersion

Carbon black (manufactured by Cabot Corporation; Regal 330): 50 parts
Anionic surfactant Neogen RK (DKS Co., Ltd.): 5 parts
Deionized water: 192.9 parts

A coloring agent dispersion (solids content: 20%) is prepared by mixing the above ingredients and processing the resulting mixture using Altimizer (manufactured by Sugino Machine Ltd.) at 240 MPa for 10 minutes.

### Preparation of Release Agent Dispersion 1

Fischer-Tropsch wax (FNP0090, manufactured by Nippon Seiro Co., Ltd.;
melting temperature Tw, 90° C.): 50 parts
Anionic surfactant (Neogen RK, manufactured by DKS Co., Ltd.): 1 part
Deionized water: 200 parts

These materials are mixed, the resulting mixture is heated to 130° C., the solids are dispersed using a homogenizer (ULTRA-TURRAX T50, manufactured by IKA-Werke GmbH & CO. KG), and then dispersion treatment is performed using a Manton-Gaulin high-pressure homogenizer (manufactured by Manton-Gaulin Manufacturing Co., Inc.) to give a release agent dispersion (solids contents, 20% by mass), in which release agent particles are dispersed. The volume-average particle diameter of the release agent particles is 180 nm.

### Production of Toners

### Production of Toner 1

Amorphous resin particle dispersion 1:169 parts
Styrene (meth)acrylic resin particle dispersion 1:33 parts
The crystalline resin particle dispersion: 53 parts
The release agent dispersion: 25 parts
The coloring agent dispersion: 33 parts
Anionic surfactant (manufactured by The Dow Chemical Company; Dowfax 2A1): 4.8 parts

These raw materials, with their temperature adjusted to 10° C., are added to a 3-L cylindrical stainless-steel container and mixed through 2 minutes of dispersion at 4000 rpm under an applied shear force using a homogenizer (manufactured by IKA-Werke GmbH & CO. KG, ULTRA-TURRAX T50).

Then 1.75 parts of a solution of aluminum sulfate in 10% nitric acid is slowly added dropwise as a flocculant, and the materials are mixed through 10 minutes of dispersion at a rotational frequency of the homogenizer of 10000 rpm, yielding a raw-material dispersion.

Thereafter, the raw-material dispersion is transferred to a polymerization pot equipped with a stirring device having a twin-paddle stirring blade and a thermometer, heating in a heating mantle is initiated with the stirring speed set to 550 rpm, and aggregate growth is allowed to proceed at 40° C. During this, the pH of the raw-material dispersion is controlled with 0.3 M nitric acid and a 1 M aqueous solution of sodium hydroxide within the range of 2.2 to 3.5. The dispersion is maintained within this pH range for approximately 2 hours, resulting in the formation of aggregates.

Then a dispersion in which 21 parts of amorphous resin particle dispersion 1 and 8 parts of styrene (meth)acrylic resin particle dispersion 1 are mixed is added, and the resulting mixture is maintained for 60 hours to induce the adhesion of binder resin particles and styrene (meth)acrylic resin particles to the surface of the aggregates. The temperature is further increased to 53° C., another 21 parts of amorphous resin particle dispersion 1 is added, and the resulting mixture is maintained for 60 hours to induce the adhesion of binder resin particles to the surface of the aggregates.

While the size and shape of the aggregates are examined using an optical microscope and Multisizer 3, a group of aggregates is sorted out. Then the pH is adjusted to 7.8 using a 5% aqueous solution of sodium hydroxide, and the resulting dispersion is maintained for 15 minutes.

Thereafter, the pH is increased to 8.0 to induce the fusion of the aggregates, and then the temperature is elevated to 85° C. Two hours after it is observed under an optical microscope that the aggregates have fused, the heating is terminated, and the dispersion is cooled at a cooling rate of 1.0° C./minute. Then screening through a 20-μm mesh sieve and washing with water are repeated, after which the aggregates are dried in a vacuum dryer, giving toner particles 1.

One hundred parts of the resulting toner particles and 0.7 parts of dimethyl silicone oil-treated silica particles (RY200, manufactured by Nippon Aerosil Co., Ltd.) are mixed using a Henschel mixer, yielding toner 1.

### Toners 2 to 9

Toners 2 to 9 are obtained in the same manner as toner 1, except that instead of styrene (meth)acrylic resin particle dispersion 1, the type of styrene (meth)acrylic resin particle dispersion specified in Table 2 is used in such an amount that the percentage of the resin particles (i.e., the styrene (meth)acrylic resin particles) to the toner particles as a whole will be the value specified in Table 2.

### Production of Developers 1 to 9

Developers 1 to 9 are obtained by mixing 8 parts of the toner specified in Table 2 and 100 parts of the carrier described below.

### Production of a Carrier

Ferrite particles (average particle diameter, 35 μm), 100 parts
Toluene, 14 parts
Styrene/methyl methacrylate copolymer (monomer ratio, 15/85), 3 parts
Carbon black, 0.2 parts

A dispersion is prepared by dispersing these ingredients excluding the ferrite particles in a sand mill, this dispersion is placed in a vacuum-degassing kneader together with the ferrite particles, and the resulting mixture is dried under reduced pressure with stirring to give a carrier.

### Example 1

The developer specified in Table 2 is set into the developing device of an image forming apparatus (“Apeos C2570 (Marble 4),” manufactured by FUJIFILM Business Innovation Corp.).

This image forming apparatus is modified to a configuration in which air heated at a fixing device is sent through a duct (60 cm long) to the inner surface of an intermediate transfer belt to heat the toner image before the second transfer (see FIG. 2) and to a configuration in which air heated at a fixing device is sent through a duct (60 cm long) to the transport path for recording paper to heat the recording paper before the second transfer (see FIG. 2). For the heating temperatures for the toner image and the recording paper, the temperatures of the toner image on the intermediate transfer belt and the recording paper that has yet to be transported to the fixing device are each measured using a noncontact laser sensor. The temperature of the heating roller in the fixing device is set to 175° C.

### Examples 2 to 19 and Comparative Example 1

The heating temperatures for the toner image and the recording paper are set as specified in Table 2 by adjusting the length of the ducts, finalizing the image forming apparatus of that example or comparative example.

In Comparative Example 1, however, the image forming apparatus is configured not to heat the toner image or the recording paper. In Table 2, the heating temperatures for the toner image and the recording paper in this comparative example are indicated as “20° C.”

### Evaluation

### Image Density Unevenness

Recording paper (C2 paper, manufactured by FUJIFILM Business Innovation Corp.) is left in a room-temperature and room-humidity environment at 22° C. and 55% RH and a high-temperature and high-humidity environment at 28° C. and 85% RH, each for 72 hours.

The image forming apparatus is left in a high-temperature and high-humidity environment at 28° C. and 85% RH for 72 hours.

Using these groups of paper and image forming apparatus, a solid black image is printed on five sheets of each group of paper. Thereafter, the five sheets with the printed image are graded based on the criteria below. (G0 to G2 are considered good)

A. The 60° gloss of the paper left in a high-temperature and high-humidity environment at 28° C. and 85% RH for 72 hours is measured at five points per sheet, and the difference between the maximum and minimum measurements is defined as ΔGloss.

B. The image density (SAD) of each group of paper, one left in a 22° C. and 55% RH environment and the other in a 28° C. and 85% RH environment, is measured at five points per sheet, the average is defined as SAD, and the difference between the SAD in the 22° C. and 55% RH environment and the SAD in the 28° C. and 85% RH environment is defined as ΔSAD.

It should be noted that the 60° gloss is measured using micro-gloss 60° gloss meter, manufactured by Tetsutani & Co., Ltd., and the SAD is measured using X-Rite 939, manufactured by X-Rite, Inc.

$$G 0 : ΔGloss \leq 3 and Δ SAD < 0.1$$

$$G 1 : 3 \leq ΔGloss \leq 5 and 0.1 \leq Δ SAD < 0.2$$

$$G 2 : 0.2 \leq Δ SAD < 0.3$$

$$G 3 : 0.3 \leq Δ SAD < 0.4$$

$$G 4 : Δ SAD > 0.4$$

TABLE 1

| | | | | | | | | | | | Number- |
|---|---|---|---|---|---|---|---|---|---|---|---|
| | | | | β- | | | | | Duration | | average |
| Resin | | n-Butyl | Acrylic | Carboxyethyl | Anionic | | Ammonium | Polymerization | of | Retention | particle |
| particle | Styrene | acrylate | acid | acrylate | surfactant | Crosslinker | persulfate | temperature | addition | time | diameter |
| dispersion | (parts) | (parts) | (parts) | (parts) | (parts) | (parts) | (parts) | (° C.) | (minutes) | (minutes) | (nm) |
| 1 | 47.9 | 51.8 | 0 | 0.3 | 2.1 | 1.65 | 5.4 | 65 | 180 | 500 | 153 |
| 2 | 47.9 | 51.8 | 0 | 0.3 | 1.2 | 1.65 | 5.4 | 65 | 180 | 500 | 291 |
| 3 | 47.9 | 51.8 | 0 | 0.3 | 1 | 1.65 | 5.4 | 65 | 180 | 500 | 305 |
| 4 | 47.9 | 51.8 | 0 | 0.3 | 3.1 | 1.65 | 5.4 | 65 | 180 | 500 | 57 |
| 5 | 46.8 | 48.9 | 2 | 0.3 | 4.2 | 1.65 | 5.4 | 65 | 180 | 500 | 19 |

TABLE 2

| | Heating | | | | Resin particles in the toner | | | |
|---|---|---|---|---|---|---|---|---|
| | temperatures | | Developer | | particles | | | Evaluation |
| | Toner | Recording | | Type | Type of resin | Particle | Amount | Image |
| | image | paper | | of | particle | diameter | % by | density |
| | ° C. | ° C. | Type | toner | dispersion | nm | mass | unevenness |
| Example 1 | 60 | 60 | 1 | 1 | 1 | 153 | 10 | G0 |
| Example 2 | 30 | 60 | 1 | 1 | 1 | 153 | 10 | G2 |
| Example 3 | 40 | 60 | 1 | 1 | 1 | 153 | 10 | G1 |
| Example 4 | 50 | 60 | 1 | 1 | 1 | 153 | 10 | G0 |
| Example 5 | 70 | 60 | 1 | 1 | 1 | 153 | 10 | G1 |
| Example 6 | 80 | 60 | 1 | 1 | 1 | 153 | 10 | G2 |
| Example 7 | 60 | 30 | 1 | 1 | 1 | 153 | 10 | G2 |
| Example 8 | 60 | 40 | 1 | 1 | 1 | 153 | 10 | G1 |
| Example 9 | 60 | 50 | 1 | 1 | 1 | 153 | 10 | G0 |
| Example 10 | 60 | 70 | 1 | 1 | 1 | 153 | 10 | G1 |
| Example 11 | 60 | 80 | 1 | 1 | 1 | 153 | 10 | G2 |
| Example 12 | 60 | 60 | 2 | 2 | 1 | 153 | 0 | G0 |
| Example 13 | 60 | 60 | 3 | 3 | 1 | 153 | 2 | G0 |
| Example 14 | 60 | 60 | 4 | 4 | 1 | 153 | 30 | G1 |
| Example 15 | 60 | 60 | 5 | 5 | 1 | 153 | 40 | G2 |
| Example 16 | 60 | 60 | 6 | 6 | 2 | 291 | 10 | G1 |
| Example 17 | 60 | 60 | 7 | 7 | 3 | 305 | 10 | G2 |
| Example 18 | 60 | 60 | 8 | 8 | 4 | 57 | 10 | G0 |
| Example 19 | 60 | 60 | 9 | 9 | 5 | 19 | 10 | G2 |
| Comparative | 20 | 20 | 1 | 1 | 1 | 153 | 10 | G4 |
| Example 1 | | | | | | | | |

From these results, it can be understood that in the Examples, compared with the Comparative Example, density unevenness in high-temperature and high-humidity environments may be reduced.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An image forming apparatus including:
an electrophotographic photoreceptor;
a charging device that charges a surface of the electrophotographic photoreceptor;
an electrostatic charge image creating device that creates an electrostatic charge image on the charged surface of the electrophotographic photoreceptor;
a developing device that houses an electrostatic charge image developer containing toner and develops the electrostatic charge image created on the surface of the electrophotographic photoreceptor into a toner image by supplying the electrostatic charge image developer;
an intermediate transfer body having a surface onto which the toner image is transferred;
a first transfer device that transfers the toner image formed on the surface of the electrophotographic photoreceptor to the surface of the intermediate transfer body;
a second transfer device that transfers the toner image on the surface of the intermediate transfer body to a surface of recording paper;
a fixing device that fixes the toner image onto the surface of the recording paper;
a first heating device that heats the toner image transferred to the surface of the intermediate transfer body before the second transfer device transfers the toner image to the surface of the recording paper; and
a second heating device that heats the recording paper before the second transfer device transfers the toner image to the surface of the recording paper.
   (((2)))

The image forming apparatus according to (((1))), wherein:
the first heating device is a device that heats the toner image using heat generated from the fixing device; and
the second heating device is a device that heats the recording paper using heat generated from the fixing device.
   (((3)))

The image forming apparatus according to (((1))) or (((2))), wherein:
a temperature to which the toner image is heated by the first heating device is 40° C. or above and 70° C. or below.
   (((4)))

The image forming apparatus according to any one of (((1))) to (((3))), wherein:
a temperature to which the recording paper is heated by the second heating device is 40° C. or above and 70° C. or below.
   (((5)))

An image forming method including:
charging a surface of an electrophotographic photoreceptor;
creating an electrostatic charge image on the charged surface of the electrophotographic photoreceptor;
developing the electrostatic charge image created on the surface of the electrophotographic photoreceptor into a toner image by supplying an electrostatic charge image developer containing toner;
transferring the toner image formed on the surface of the electrophotographic photoreceptor to a surface of an intermediate transfer body;
transferring the toner image on the surface of the intermediate transfer body to a surface of recording paper;
fixing the toner image onto the surface of the recording paper;
heating the toner image transferred to the surface of the intermediate transfer body before the toner image is transferred to the surface of the recording paper; and
heating the recording paper before the toner image is transferred to the surface of the recording paper.
   (((6)))

The image forming method according to (((5))), wherein:
the toner contains toner particles containing at least one binder resin and resin particles.
   (((7)))

The image forming method according to (((6))), wherein:
an amount of the resin particles is 2% by mass or more and 30% by mass or less of the toner particles.
   (((8)))

The image forming method according to (((6))) or (((7))), wherein:
the resin particles are styrene (meth)acrylic resin particles.
   (((9)))

The image forming method according to any one of (((6))) to (((8))), wherein:
an average primary particle diameter of the resin particles is 20 nm or more and 300 nm or less.

What is claimed is:

1. An image forming apparatus comprising:
an electrophotographic photoreceptor;
a charging device that charges a surface of the electrophotographic photoreceptor;
an electrostatic charge image creating device that creates an electrostatic charge image on the charged surface of the electrophotographic photoreceptor;
a developing device that houses an electrostatic charge image developer containing toner and develops the electrostatic charge image created on the surface of the electrophotographic photoreceptor into a toner image by supplying the electrostatic charge image developer;
an intermediate transfer body having a surface onto which the toner image is transferred;
a first transfer device that transfers the toner image formed on the surface of the electrophotographic photoreceptor to the surface of the intermediate transfer body;
a second transfer device that transfers the toner image on the surface of the intermediate transfer body to a surface of recording paper;
a fixing device that fixes the toner image onto the surface of the recording paper;
a first heating device that heats the toner image transferred to the surface of the intermediate transfer body before the second transfer device transfers the toner image to the surface of the recording paper; and
a second heating device that heats the recording paper before the second transfer device transfers the toner image to the surface of the recording paper.

2. The image forming apparatus according to claim 1, wherein:
the first heating device is a device that heats the toner image using heat generated from the fixing device; and
the second heating device is a device that heats the recording paper using heat generated from the fixing device.

3. The image forming apparatus according to claim 1, wherein:
a temperature to which the toner image is heated by the first heating device is 40° C. or above and 70° C. or below.

4. The image forming apparatus according to claim 1, wherein:
a temperature to which the recording paper is heated by the second heating device is 40° C. or above and 70° C. or below.

5. An image forming method comprising:
charging a surface of an electrophotographic photoreceptor;
creating an electrostatic charge image on the charged surface of the electrophotographic photoreceptor;
developing the electrostatic charge image created on the surface of the electrophotographic photoreceptor into a toner image by supplying an electrostatic charge image developer containing toner;
transferring the toner image formed on the surface of the electrophotographic photoreceptor to a surface of an intermediate transfer body;
transferring the toner image on the surface of the intermediate transfer body to a surface of recording paper;
fixing the toner image onto the surface of the recording paper;
heating the toner image transferred to the surface of the intermediate transfer body before the toner image is transferred to the surface of the recording paper; and
heating the recording paper before the toner image is transferred to the surface of the recording paper.

6. The image forming method according to claim 5, wherein:
the toner contains toner particles containing a binder resin and resin particles.

7. The image forming method according to claim 6, wherein:
an amount of the resin particles is 2% by mass or more and 30% by mass or less of the toner particles.

8. The image forming method according to claim 6, wherein:
the resin particles are styrene (meth)acrylic resin particles.

9. The image forming method according to claim 6, wherein:
an average primary particle diameter of the resin particles is 20 nm or more and 300 nm or less.
